(19) United States
(12) Patent Application Publication
(10) Pub. No.: US 2021/0372051 A1
(43) Pub. Date: Dec. 2, 2021

(54) SURFACE-TREATED FIBROUS MATERIALS AND METHODS FOR THEIR PREPARATION

(71) Applicant: Stora Enso OYJ, Helsinki (FI)

(72) Inventors: Isto Heiskanen, Imatra (FI); Katja Lyytikäinen, Imatra (FI); Gisela Cunha, Nacka (SE); Kaj Backfolk, Lappeenranta (FI)

(73) Assignee: Stora Enso OYJ, Helsinki (FI)

(21) Appl. No.: 17/299,988

(22) PCT Filed: Dec. 20, 2019
(86) PCT No.: PCT/IB2019/061182

§ 371 Date: Jun. 4, 2021

(30) Foreign Application Priority Data
Dec. 21, 2018 (SE) 1851645-0

(51) Int. Cl. D21H 11/18; D21H 11/20; D21H 17/66; D21H 23/46

(52) U.S. Cl. CPC D21H 11/18; D21H 23/46; D21H 17/66; D21H 11/20

(57) ABSTRACT

The present invention relates to a method for preparing a surface-treated fibrous material comprising phosphorylated nanocellulose, in which a fibrous material is surface treated with a solution comprising at least one multivalent metal ion followed by drying and post-curing to improve the barrier properties of the material. Fibrous materials as such are also provided.

The present technology relates to methods for preparing a surface-treated fibrous material comprising nanocellulose, in which a fibrous material is surface treated with a solution comprising at least one multivalent metal ion. Fibrous materials as such are also provided for example for use in paper or paperboard laminates. The present technology allows improved Oxygen Transmission Rates (OTRs) for the fibrous material, while operating on an industrial scale.

### BACKGROUND

Cellulose films are often very sensitive to water, which limits their use in applications where moisture is present, e.g. absorbent hygiene articles, medical devices and food and liquid packaging. There is a need for fibrous materials, e.g. MFC film, or laminates or structures comprising MFC films or coatings, having improved gas barrier properties at relative high humidity (RH) and preferably at elevated temperatures, for example for use under tropical conditions, which is useful for packaging applications, free standing film or in composites.

The problem of moisture sensitivity of nanocellulose films is described in many scientific articles including a number of theories and effects of the water vapor-induced swelling and such as good oxygen barrier, see review e.g. by Wang, J., et al., (Moisture and Oxygen Barrier Properties of Cellulose Nanomaterial-Based Films, ACS Sustainable Chem. Eng., 2018, 6 (1), pp 49-70). In addition to the role of cellulose crystallinity, polymer additives (Kontturi, K., Kontturi, E., Laine, J., Specific water uptake of thin films from nanofibrillar cellulose, Journal of Materials Chemistry A, 2013, 1, 13655), a number of various hydrophobic coating solutions have been suggested.

Metal salts have been mixed to cellulosic fibers in order to e.g. increase adsorption of anionic charged polyelectrolytes. The use of metal salts has also been used to modify pulps and nanocellulose such as in JP2017149103A where the modification provides odor control and antimicrobial effect.

In JP2017149102A, on the other hand, the modified nanofibers comprising metal ions are further kneaded and mixed with thermoplastic polymer, in order to provide a packaging material with good antimicrobial and deodorizing effect.

JP2018028172A and JP06229090B1 (carboxymethylated nanofiber) describes examples of the use of nanofibers in deodorizing applications such as sanitary products and tissue.

Many of the existing technologies are not industrially scalable, nor suitable for high-speed or large-scale manufacturing concepts. The use of metal salts in mixing and modification of nanocellulose is technically difficult and may lead to problems with corrosion, unbalanced wet-end charge, depositions in the wet-end, insufficient material and fiber retention. The use of metal salts in the furnish might also lead to uncontrolled level of heterogenous cross-linking and gel forming, which will influence dewatering rate and subsequent film and barrier quality.

A problem remains how to make and ensure a more efficient metal treatment of fibrous materials and to provide enhanced barrier properties, especially at high relative humidities such as under tropical conditions.

### SUMMARY

Encouraging results with phosphorylated nanocellulose complexed with metal ions such as Ca²⁺, Al³⁺ etc. have been found by the present inventors. The present invention relates to treatment of a fibrous material comprising phosphorylated nanocellulose in such was that the fibrous material will have very good barrier properties, e.g. OTR values, even at high humidity.

A method is provided for preparing a surface-treated fibrous material comprising nanocellulose, said method comprising the steps of:
a. forming a fibrous material from a suspension comprising phosphorylated nanocellulose
b. surface treatment of the fibrous material with a solution comprising at least one multivalent metal ion to obtain a surface-treated fibrous material
c. drying the surface-treated fibrous material,
d. post-curing of the surface-treated fibrous material

wherein the barrier properties of the fibrous material are improved.

A fibrous material, in particular a fibrous film material, is also provided. Additional features of the method and materials are provided in the following text and the patent claims.

### DETAILED DISCLOSURE

As set out above a method is provided for preparing a surface-treated fibrous material comprising nanocellulose.

A method is provided for preparing a surface-treated fibrous material comprising nanocellulose, said method comprising the steps of:
a. forming a fibrous material from a suspension comprising phosphorylated nanocellulose
b. surface treatment of the fibrous material with a solution comprising at least one multivalent metal ion to obtain a surface-treated fibrous material
c. drying the surface-treated fibrous material,
d. post-curing of the surface-treated fibrous material

wherein the barrier properties of the surface-treated fibrous material are improved.

Fibrous Material

The fibrous material used in this method is formed from a suspension comprising phosphorylated nanocellulose.

In an embodiment, the suspension comprising phosphorylated nanocellulose further comprises as a main fraction, for example, any other types of nanocellulose materials or nanocellulose combined with other types of fibers, such as kraft pulp, dissolving pulp fiber or e.g. mechanical or semimechanical or CTMP pulps

Nanocellulose (also called Microfibrillated cellulose (MFC) or cellulose microfibrils (CMF)) shall in the context of the present application mean a nano-scale cellulose particle fiber or fibril with at least one dimension less than 100 nm. Nanocellulose might also comprise partly or totally fibrillated cellulose or lignocellulose fibers. The cellulose fiber is preferably fibrillated to such an extent that the final specific surface area of the formed nanocellulose is from about 1 to about 300 m²/g, such as from 10 to 200 m²/g or more preferably 50-200 m²/g when determined for a solvent exchanged and freeze-dried material with the BET method.

In an embodiment, nanocellulose may contain substantial amount of phosphorylated fines or fibers or fibril agglomerates, such that the suspension (0.1 wt %) is turbid.

Various methods exist to make nanocellulose, such as single or multiple pass refining, pre-hydrolysis followed by refining or high shear disintegration or liberation of fibrils. One or several pre-treatment steps are usually required in order to make nanocellulose manufacturing both energy-efficient and sustainable. The cellulose fibers of the pulp to be supplied may thus be pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl, aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into nanocellulose.

The nanofibrillar cellulose may contain some hemicelluloses; the amount is dependent on the plant source. Mechanical disintegration of the pre-treated fibers, e.g. hydrolysed, pre-swelled, or oxidized cellulose raw material is carried out with suitable equipment such as a refiner, grinder, homogenizer, colloider, friction grinder, ultrasound sonicator, single—or twin-screw extruder, fluidizer such as microfluidizer, macrofluidizer or fluidizer-type homogenizer. Depending on the MFC manufacturing method, the product might also contain fines, or nanocrystalline cellulose or e.g. other chemicals present in wood fibers or in papermaking process. The product might also contain various amounts of micron size fiber particles that have not been efficiently fibrillated.

Nanocellulose can be produced from wood cellulose fibers, both from hardwood or softwood fibers. It can also be made from microbial sources, agricultural fibers such as wheat straw pulp, bamboo, bagasse, or other non-wood fiber sources. It is preferably made from pulp including pulp from virgin fiber, e.g. mechanical, chemical and/or thermomechanical pulps. It can also be made from broke or recycled paper.

Phosphorylated nanocellulose (also called phosphorylated microfibrillated cellulose; P-MFC) is typically obtained by reacting cellulose fibers soaked in a solution of NH₄H₂PO₄, water and urea and subsequently fibrillating the fibers to P-MFC. One particular method involves providing a suspension of cellulose pulp fibers in water, and phosphorylating the cellulose pulp fibers in said water suspension with a phosphorylating agent, followed by fibrillation with methods common in the art. Suitable phosphorylating agents include phosphoric acid, phosphorus pentaoxide, phosphorus oxychloride, diammonium hydrogen phosphate and sodium dihydrogen phosphate.

In the reaction to form P-MFC, alcohol functionalities (—OH) in the cellulose are converted to phosphate groups (—OPO₃²⁻). In this manner, crosslinkable functional groups (phosphate groups) are introduced to the pulp fibers or microfibrillated cellulose. Typically, the P-MFC is in the form of its sodium salt.

A suspension of phosphorylated nanocellulose is used to form the fibrous material. Typically, the fibrous material comprises phosphorylated nanocellulose in an amount of between 0.01-100 wt %, such as between 0.1 and 50 wt %, suitably between 0.1 and 25 wt %, such as between 0.1 and 10 wt %, or between 0.1 and 5 wt %. The phosphorylated nanocellulose preferably has a high degree of substitution; i.e. in the range of 0.1-4.0, preferably 0.5-3.8, more preferably 0.6-3.0, or most pref. 0.7 to 2.0 mmol/g of phosphate groups as e.g. measured by a titration method or by using elemental analysis described in the prior art.

The suspension used to form the fibrous material is typically an aqueous suspension. The suspension may comprise additional chemical components known from papermaking processes. Examples of these may be nanofillers or fillers such as nanoclays, bentonite, talc, calcium carbonate, kaolin, SiO2, Al2O3, TiO2, gypsum, etc. The fibrous substrate may also contain strengthening agents such as native starch, cationic starch anionic starch or amphoteric starch. The strengthening agent can also be synthetic polymers. In a further embodiment, the fibrous substrate may also contain retention and drainage chemicals such as cationic polyacrylamide, anionic polyacrylamide, silica, nanoclays, alum, PDADMAC, PEI, PVam, etc. In yet a further embodiment, the fibrous material may also contain other typical process or performance chemicals such as dyes or fluorescent whitening agents, defoamers, wet strength resins, biocides, hydrophobic agents, barrier chemicals, cross-linking agents, etc.

The nanocellulose suspension may additionally comprise non-modified, cationic or anionic nanocellulose; such as carboxymethylated nanocellulose.

The forming process of the fibrous material from the suspension may be casting or wet-laying or coating on a substrate from which the fibrous material is not removed. The fibrous material formed in the present methods should be understood as having two opposing primary surfaces. Accordingly, the fibrous material may be a film or a coating, and is most preferably a film. The fibrous material has a grammage of between 1-80, preferably between 10-50 gsm, such as e.g. 10-40 gsm. For coatings in particular, the grammage can be low, e.g. 1-10 gsm (or even 0.1-10 gsm)

In one aspect of the methods described herein, the fibrous material is surface-treated after it has been dried, e.g. while it has a solid content of 40-99.5% by weight, such as e.g. 60-99% by weight, 80-99% by weight or 90-99% by weight.

In another aspect of the methods described herein, the fibrous material is surface-treated before it has been dewatered and dried, e.g. while it has a solid content of 0.1-80% by weight, such as e.g. 0.5-75% by weight or 1.0-50% by weight.

In one aspect of the methods described herein, the fibrous material to be surface-treated has been formed by wet-laying and has a solid content of 50-99% by weight.

In another aspect of the methods described herein, the fibrous material to be surface-treated has been formed by casting and has a solid content of 50-99% by weight.

In another aspect of the methods described herein, the fibrous material is surface-treated after it has been dried, e.g. while it has a solid content of 50-99% by weight, such as e.g. 60-99% by weight, 80-99% by weight or 90-99% by weight.

In another aspect of the methods described herein, the fibrous material is surface-treated before it has been dried, e.g. while it has a solid content of 0.1-50% by weight, such as e.g. 1-40% by weight or 10-30% by weight.

In another aspect of the methods described herein, the fibrous material to be surface-treated is a free standing film having a grammage in the range of 1-100 g/m² after metal ion treatment, more preferred in the range of 10-50 g/m² after metal ion treatment. This free-standing film may be directly attached onto a carrier substrate or attached via one or more tie layers.

The film can either be made with cast forming or cast coating technique, i.e. deposition of a nanocellulose suspension on a metal or plastic belt.

Another way to prepare the barrier films is by utilizing a wet laid technique such as a wire through which the water is penetrated and main fraction of components (nanocellulose, fibers and other process aids and functional chemicals) are retained in the sheet. One method is a papermaking process or modified version thereof.

Another way to make base films is to use a carrier surface such as plastic, composite, or paper or paperboard substrate, onto which the film is directly formed and not removed.

The manufacturing pH during the film making should preferably be higher than 3, more preferably higher than 5.5, but preferably less than 12 or more preferably less than 11, since it is believed that this probably influences the initial OTR values of the film.

The fibrous material may include other fibrous materials. For instance, the fibrous material may comprise other anionic nanocellulose (derivatized or physically grafted with anionic polymers) in the range of 1-50 wt %. The fibrous material to be surface treated may also comprise native (non-derivatized) nanocellulose. The fibrous material may also comprise pulp fibers and coarse fines, preferably in the range of 0-60 wt %.

The fibrous material may also comprise one or more fillers, such as a nanofiller, in the range of 1-50% by weight. Typical nanofillers can be nanoclays, bentonite, silica or silicates, calcium carbonate, talcum, etc. Preferably, at least one part of the filler is a platy filler. Preferably, one dimension of the filler should have an average thickness or length of 1 nm to 10 μm.

The surface-treated fibrous material preferably has a substrate-pH of 3-12 or more preferred a surface-pH of 5.5-11. More specifically, the surface-treated fibrous material may have a substrate-pH higher than 3, preferably higher than 5.5. In particular, the surface-treated fibrous material may have a substrate-pH less than 12, preferably less than 11.

The pH of the surface of the fibrous material is measured on the final product, i.e. the dry product. “Surface pH” is measured by using fresh pure water which is placed on the surface. Five parallel measurements are performed and the average pH value is calculated. The sensor is flushed with pure or ultra-pure water and the paper sample is then placed on the moist/wet sensor surface and pH is recorded after 30 s. Standard pH meters are used for the measurement.

Before surface treatment, the fibrous material suitably has an Oxygen Transmission Rate (OTR) value in the range 100-5000 cc/m²/24 h (38° C., 85% RH) according to ASTM D-3985 at a grammage between 10-50 gsm, more preferably in the range of 100-1000 cc/m²/24 h. In some cases, the OTR values obtained are not even measurable with standard methods.

Metal Ion Solution

The method requires a solution comprising at least one multivalent metal ion. The solvent for the multivalent metal ion solution is predominantly water (e.g. over 50% v/v water), although other co-solvents and additives can be added. For instance, the multivalent metal ion solution may further comprise CMC, starch, guar gum, MFC or anionic, cationic or amphoteric polysaccharide, or mixtures thereof. In another embodiment, the solution may also contain other crosslinking agents.

Typically, the concentration of the divalent or trivalent metal ions in the solution is >0.01 M solution or more preferred >0.1 M solution or most preferred >1.0 M solution. The upper limit is the solubility of the salts, although higher concentrations can be used as well.

The solution comprising at least one multivalent metal ion preferably comprises divalent or trivalent metal ions, or mixtures thereof. Of these, trivalent metal ions are preferred. The divalent or trivalent metal ions may be selected from the group consisting of MgCl₂, CaCl₂), AlCl₃ and FeCl₃, or mixtures thereof, preferably AlCl₃.

The counterions used in the metal ion solution may be any appropriate counterion which provides the required metal ion solubility in the solution, and which are compatible with other papermaking solutions and components. Examples of counterions are halides such as chlorides.

The amount and types of additives of course greatly influence the viscosity, and the exact chosen viscosity is also depending on the process used. In one embodiment, the solution comprising at least one multivalent metal ion has a viscosity between 1-3000 mPas, more preferred 1-2000 or most preferred 1-1500 as measured by Brookfield at 23C and at rpm of 100 using e.g. spindle #6.

In general, a viscosity within this range improves the industrial scalability of the methods.

Surface Treatment

The method disclosed herein require surface treatment of the fibrous material with a solution comprising at least one multivalent metal ion to obtain a surface-treated fibrous material. Surface treatment may take place on only one surface of the fibrous material, but may also advantageously take place on both surfaces.

The fibrous material obtained by the surface treatment according to the invention has improved barrier properties. With barrier properties is mean improved resistance for the products to penetrate the barrier, such as gas, oxygen, water, water vapor, fat or grease.

It may be advantageous to only treat one or both surfaces of the fibrous material to such an extent that the metal ion solution does not penetrate into the entire fibrous material in the thickness direction. In this way the amount of metal ion solution can be reduced. Another reason is that it may be preferred to have some un-cross-linked material in the middle of the material to control strength properties. Such partial penetration of metal ion solution could also be a reason for only treating one surface of the fibrous material. In the present context partial penetration means that most of the metals are located at the surface or in the vicinity of the surface thus leading to a layered structure. This may be identified e.g. from a cross-section images and elemental analysis of the components in the cross-section.

Generally, the solution comprising at least one multivalent metal ion may be applied in an amount between 0.05-50 gsm of the fibrous material, more preferred in an amount of 0.1-10 gsm of the fibrous material.

After treatment with the solution comprising at least one multivalent metal ion, the concentration of the divalent or trivalent metal ions in the fibrous material is suitably in the range of 0.1-30 kg/ton, preferably 0.1-10 kg/ton.

The surface treatment is performed on a wet or dry fibrous material. The surface treatment step is followed by drying, preferably a high temperature, of the surface-treated fibrous material. The drying may take place at temperatures between 60-260° C., more preferred at temperatures of 70-220° C. and most preferred at temperatures of 80-200° C. The temperatures are measured as the surface temperature of the web. The drying can be made with drying cylinders, extended belt or nip dryers, radiation dryers, air dryers etc. or combinations thereof. Drying may also be in the form of high temperature calandering.

The surface might also be activated prior the treatment in order to adjust wetting such as with corona or plasma.

Typically the fibrous material is dewatered and then dried to obtain a solid content of more than 1% by weight, preferably more than 50% by weight.

After drying of the fibrous material, it is post-cured, i.e. treated at an increased temperature. The post-curing can be seen as a second drying step done at a high dry content. The post-curing can be done in roll or sheet form. The temperature during post-curing is preferably done at an average temperature of at least 40° C., more preferably at least 50° C. or most preferably at least 60° C., preferably for a period of at least 1 hour, more preferably 2 hours and most preferably at least 6 hours (average temperature inner, mid and outer layer). The dry content of the fibrous material after drying and before post-curing is preferably above 94 wt-%, preferably above 96 wt-% and even more preferred above 97 wt-%. It is preferred that the fibrous material has a dry content of 95-99 wt-%, preferably between 96-980 wt-% before being conducted to post-curing. It has surprisingly been found that by surface treating a fibrous material followed by drying and post-curing it is possible to increase the dry content of the material more compared to a material that has not been surface treated according to the invention. It is important to be able to remove as much water as possible in order for the cross-linking to be as efficient as possible. Consequently, it is believed that the increased dry content is one reason for the achieved improvement in barrier properties due to improved cross-linking.

Before or during dewatering, the fibrous material may be partly crosslinked by treatment with at least one crosslinking agent. Such a crosslinking agent is suitably selected from the group consisting of glyoxal, glutaraldehyde, metal salts, and cationic polyelectrolyte.

Typical techniques for surface treatment are those common in the field of papermaking. The surface treatment may be performed by immersing, spraying, curtain, size press, film press, blade, rotogravure, inkjet, or other non-impact or impact coating methods. In one aspect, the surface treatment is an ion-exchange. The surface treatment may be performed under pressure and/or under ultrasound. In this manner, the degree of penetration of the multivalent metal ion solution can be controlled.

The methods described herein may include one or more additional steps. For instance, they may further comprise the step of rinsing or immersing in rinsing fluid following the surface treatment. Preferably, the methods further comprise the step of drying at elevated temperature and/or pressure following the surface treatment and/or the rinsing step.

Surface treatment of the fibrous material with the multivalent metal ion solution will provide crosslinked phosphorylated nanocellulose. It is contemplated that the ionic substituents on the fibers are cross-linked with the metal ions. It is believed that this is one of the reasons for the improved barrier properties of the material. In one embodiment, the degree of crosslinking may be measured by the moisture sensitivity i.e. barrier properties at high RH. Other means such as spectroscopic methods or gel behavior dissolution can also be used to estimate cross-linking behavior.

Surface-Treated Fibrous Material

The present technology provides a fibrous material obtained via the methods described herein, as well as the fibrous material per se.

The methods described herein provide a surface-treated fibrous material. The fibrous material after surface-treatment, drying and post-curing preferably has an oxygen Transmission Rate (OTR) value in the range of 1-20 cc/m²/24 h (38° C., 85% RH) according to ASTM D-3985 at a grammage between 10-50 gsm. Consequently, by treating the fibrous material according to the invention, i.e. by surface treatment with a solution comprising a multivalent meal ion followed by drying and post-curing makes it possible to provide the material with good barrier properties even at humidity.

A fibrous material is provided comprising phosphorylated nanocellulose and divalent or trivalent metal ions in the range of 0.01%-3% by weight, which fibrous material has an oxygen Transmission Rate (OTR) value in the range of 1-20 cc/m²/24 h (38° C., 85% RH) according to ASTM D-3985 and a grammage between 10-50 gsm.

Suitably, the grammage is between 1-100, preferably 10-50 g/m2 if it is a free standing film, and between 1-100, most preferably 1-30 g/m2 if it is a directly attached onto a carrier substrate.

The fibrous material can be used as such or laminated with plastic films, paper or paperboards. The paper or paperboard used may also be polymer or pigment coated. The fibrous film material should be substantially free of pinholes.

### Experimental

Nanocellulose Properties

The charge properties of the nanocellulose used in the examples below is as followed.

The charge of the nanocellulose used was measured by titration with 0.001 N p-DADMAC (Mw=107000 g/mol) for 0.1 g/I or 0.5 g/l of nanocellulose depending on total cationic demand). The nanocellulose used in the experiments is:
i. High DS p-MFC (pH 8, 0.01 M NaCl)=n. 1460 μeq/g

A. Surface Treatment of the Film

#1 (reference). Cast coated phosphorylated nanocellulose (High DS p-MFC according to i) above) film was prepared to a grammage of 20 gsm. No soaking was made. The moisture content of the film after drying was 13.4 wt-% and after post-curing was 12.9 wt-%.

#2 Same as #1 but immersed in ultrapure water.

#3 Same film as #1 but immersed in NaCl solution.

#4 Same films as in #1 but soaked in CaCl₂ solution.

#5 Same as in #1 but film soaked in AlCl₃ solution. The moisture content of the film after drying was 14.2 wt-% and after post-curing the moisture content was 11.8 wt-%.

After surface treatment the samples were dried at 60° C. overnight. Some samples were thereafter subjected to post-curing at 105° C. The OTR and WVTR values were thereafter measured on the treated films. The OTR values were measured according to ASTM D-3985 and the WVTR values were measured according to ASTM F-1249. The results from the tests are shown in Table 1.

TABLE 1

| | | | Dry | | OTR, | WVTR, |
|---|---|---|---|---|---|---|
| | | | cont. | | cc/m²/ | g/m²/ |
| | | | after | Curing at | day | day |
| | Soaking | | drying | 105° C./ | 38° C./ | 23° C./ |
| | Solution | Drying | (wt-%) | overnight | 85% RH | 50% RH |
| #1 | None | 23° C./ | | No | 107 | 172 |
| | (ref) | 50% RH | | Yes | — | — |
| #2 | UHP | 60° C./ | — | No | 150 | 373 |
| | water | Overnight | | Yes | 162 | — |
| #3 | NaCl | 60° C. / | 98.4 | No | 149 | 325 |
| | | Overnight | | Yes | 185 | |
| #4 | CaCl2 | 60° C./ | 98 | No | 36 | 458 |
| | | Overnight | | Yes | 30 | |
| #5 | AlCl3 | 60° C./ | 96.7 | No | 250 | 712 |
| | | Overnight | | Yes | 14 | 297 |

From Table 1 it is clear that treatment with monovalent metal salts (sample #3) does not lead to a film with improved barrier properties. Samples #4 and #5 has very good barrier properties especially after drying and post-curing treatment.

The equilibrium moisture content of some of the films were measured after drying and after post-drying. The equilibrium moisture content is the amount of water that the oven-dry film absorbs when placed into a condition where the relative humidity is 50% in 23° C. The results can be found in Table 2.

TABLE 2

| | | Equilibrium Moisture |
|---|---|---|
| Sample | Drying | content (wt %) |
| p-MFC no | 60° C./overnight | 13.4 |
| surface treatment | 60° C./overnight + | 12.9 |
| | 105° C. overnight | |
| p-MFC treated | 60° C./overnight | 14.2 |
| with AlCl3 | 60° C./overnight + | 11.8 |
| | 105° C. overnight | |

It can bee seen that after drying and post-curing of the surface treated film the film does not absorb as much water from humid air compared to non-treated films or film that only has been dried. Consequently, the drying and post-curing results in a film with improved barrier properties.

1. A method for preparing a surface-treated fibrous material comprising nanocellulose, said method comprising the steps of:
a. forming a fibrous material from a suspension comprising phosphorylated nanocellulose,
b. surface treatment of the fibrous material with a solution comprising at least one multivalent metal ion to obtain a surface-treated fibrous material,
c. drying the surface-treated fibrous material, and
d. post-curing of the surface-treated fibrous material,
wherein the barrier properties of the surface-treated fibrous material are improved.

2. The method according to claim 1 wherein the post-curing is performed at an average temperature of at least 40° C., for at least 1 hour.

3. The method according to claim 1, wherein the solution comprising at least one multivalent metal ion comprises divalent ions, trivalent ions, or mixtures thereof.

4. The method according to claim 3, wherein the divalent ions and the trivalent ions are selected from a group consisting of: MgCl₂, CaCl₂), AlCl₃, FeCl₃, and mixtures thereof.

5. The method according to claim 1, wherein a concentration of the at least one multivalent metal ion in the solution is >0.01 M solution.

6. The method according to claim 1, wherein the solution comprising the at least one multivalent metal ion is applied in an amount between 0.05-50 gsm of the fibrous material.

7. The method according to claim, further comprising the step of:
drying the surface treated fibrous material.

8. The method according to claim 1, wherein the phosphorylated nanocellulose of the fibrous material is crosslinked after treatment with the solution comprising the at least one multivalent metal ion.

9. The method according to claim 1, wherein the fibrous material has an Oxygen Transmission Rate (OTR) value in a range of 100-5000 cc/m²/24 h (38° C., 85% RH) according to ASTM D-3985 at a grammage between 10-50 gsm before surface treatment.

10. The method according to claim 1, wherein the fibrous material after surface-treatment has an Oxygen Transmission Rate (OTR) value in a range of 1-20 cc/m²/24 h (38° C., 85% RH) according to ASTM D-3985 at a grammage between 10-50 gsm.

11. The method according to claim 1, wherein the forming of the fibrous material comprises casting or wet-laying.

12. The method according to claim 1, wherein the fibrous material comprises a film or a coating.

13. The method according to claim 1, wherein the fibrous material to be surface-treated is a free standing film having a grammage in the range of 1-100 g/m².

14. The method according to claim 1, wherein the surface treatment comprises immersing, spraying, curtain size press, film press, blade, rotogravure, or inkjet coating methods.

15. The method according to claim 1, wherein the surface treatment is performed under pressure, or under ultrasound, or under both.

16. A fibrous material comprising:
phosphorylated nanocellulose and divalent or trivalent metal ions in a range of 0.01%-3% by weight,
wherein the fibrous material has an oxygen Transmission Rate (OTR) value in the range of 1-20 cc/m²/24 h (38° C., 85% RH) according to ASTM D-3985 and a grammage between 10-50 gsm.

17. The fibrous material according to claim 16, wherein the phosphorylated nanocellulose comprises a phosphorylated microfibrillated cellulose (P-MFC) having a high degree of substitution in the range of 0.1-4.0 mmol/g.

18. (canceled)

19. The method according to claim 13, wherein the free-standing film is directly attached onto a carrier substrate.
